(19) United States
(12) Patent Application Publication
(10) Pub. No.: US 2015/0081530 A1
(43) Pub. Date: Mar. 19, 2015

(54) IMAGE FORMING APPARATUS CAPABLE OF EXECUTING PRINT PROCESSING BASED ON INPUT IMAGE DATA, INFORMATION PROCESSING METHOD, AND STORAGE MEDIUM

(71) Applicant: CANON KABUSHIKI KAISHA, Tokyo (JP)

(72) Inventor: Keisuke Aizono, Kawasaki-shi (JP)

(21) Appl. No.: 14/481,735

(22) Filed: Sep. 9, 2014

(30) Foreign Application Priority Data
Sep. 13, 2013 (JP) 2013-190776

(51) Int. Cl. G06Q 20/40; H04N 1/44; G06F 3/12; G06Q 20/34; G06K 15/00

(52) U.S. Cl. CPC G06Q 20/407; G06Q 20/356; G06K 15/4045; G06F 3/1292; H04N 1/4426; H04N 2201/0094
USPC 705/39

(57) ABSTRACT

An image forming apparatus including an obtaining unit configured to obtain from a device on which electronic money is recorded, identification information for identifying the device and electronic money information, a deduction unit configured to deduct an amount required for executing a print process based on the electronic money information, a storage unit configured to store balance information that indicates a balance relating to the print process by associating the balance information with the identification information, and a refund unit configured to refund the balance indicated by the balance information associated with the identification information in response to the identification information obtained by the obtaining unit for a different print process.

### BACKGROUND OF THE INVENTION

1. Field of the Invention

The present invention relates to an image forming apparatus, an information processing method, and a storage medium.

2. Description of the Related Art

Recently, the use of electronic money to perform settlement (payment) using a pre-paid non-contact card on public transportation system, in supermarkets and the like has been spreading. In such a payment method, after the price (amount) of a service or a product has been confirmed, that amount is deducted from the non-contact card by swiping the non-contact card (electronic money) over a card processor. Consequently, for a retail system in which the amount is confirmed after the product or service has been provided, to perform payment more reliably, the non-contact card has to be held in the card processor until payment is complete. However, by holding the card in this manner, the card processor becomes complex and expensive, and also the convenience of the non-contact card worsens.

To solve such a problem, Japanese Patent Application Laid-Open No. 2011-164987 discusses a method in which the required amount is deducted from the non-contact card before providing a copy service, and if a difference with the actual confirmed amount occurs, the previous deduction is cancelled and a deduction is performed again from the non-contact card.

However, in the method discussed in Japanese Patent Application Laid-Open No. 2011-164987, a user may not notice the refund, so that if the user does not swipe the non-contact card again, refund processing cannot be performed.

### SUMMARY OF THE INVENTION

According to an aspect of the present invention, an image forming apparatus includes an obtaining unit configured to obtain from a device on which electronic money is recorded, identification information for identifying the device and electronic money information, a deduction unit configured to deduct an amount required for executing a print process based on the electronic money information, a storage unit configured to store balance information that indicates a balance relating to the print process by associating the balance information with the identification information, and a refund unit configured to refund the balance indicated by the balance information associated with the identification information in response to the identification information obtained by the obtaining unit for a different print process.

Further features of the present invention will become apparent from the following description of exemplary embodiments with reference to the attached drawings.

### BRIEF DESCRIPTION OF THE DRAWINGS

FIG. 1 illustrates an example of a system configuration of a printing system.

FIG. 2 illustrates basic charging processing with a non-contact card.

FIG. 3 is a flowchart illustrating details of refund processing according to a first exemplary embodiment.

FIGS. 4A-4F illustrate various display screens.

FIG. 5 is a flowchart illustrating details of refund processing according to a second exemplary embodiment.

FIG. 6 illustrates processing for deducting a deposit amount from a required amount.

### DESCRIPTION OF THE EMBODIMENTS

Various exemplary embodiments, features, and aspects of the invention will be described in detail below with reference to the drawings.

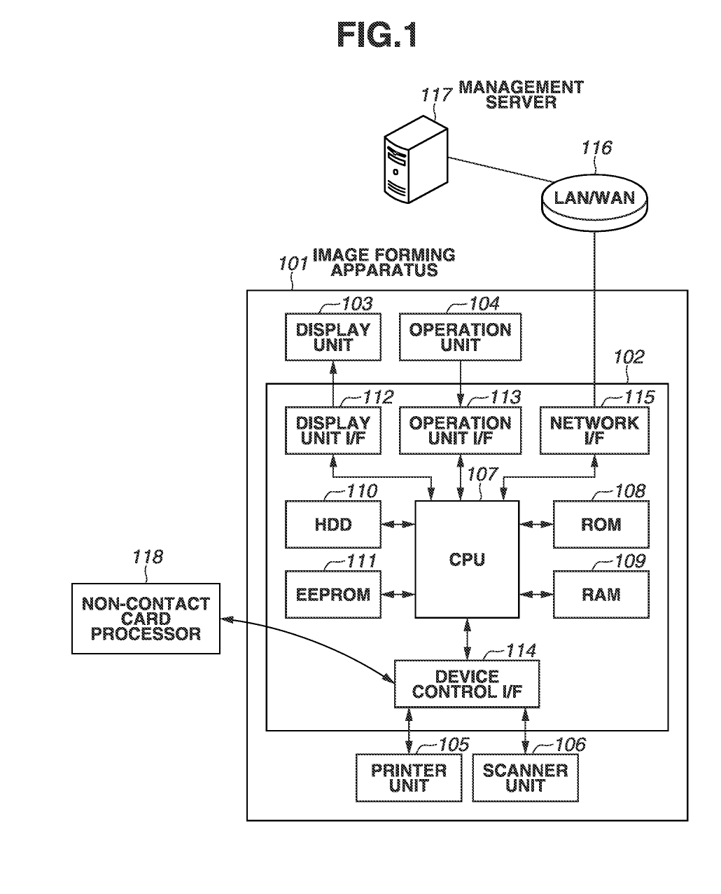

FIG. 1 illustrates an example of a system configuration of a printing system.

An image forming apparatus 101 includes a controller unit 102, a display unit 103, an operation unit 104, a printer unit 105, and a scanner unit 106.

The display unit 103, which includes a light-emitting diode (LED) and a liquid crystal display, displays operation content made by an operator and an internal state of the apparatus. The operation unit 104 receives operations from the operator. The operation unit 104 may include a plurality of operation buttons, or may even be realized as a touch display with the display unit 103.

The printer unit 105 prints image data transmitted from the controller unit 102 on printing paper based on a print instruction from the controller unit 102. The printer unit 105 is connected to the controller unit 102 via a device control interface (I/F) 114.

The scanner unit 106 receives scan instructions from the controller unit 102, performs scan operations, and transmits the scanned image data to the controller unit 102. The scanner unit 106 is connected to the controller unit 102 via the device control I/F 114.

The controller unit 102 includes a central processing unit (CPU) 107, a read-only memory (ROM) 108, a random-access memory (RAM) 109, a hard disk drive (HDD) 110, an electrically erasable programmable read-only memory (EEPROM) 111, a display unit I/F 112, an operation unit I/F 113, a device control I/F 114, and a network I/F 115.

The CPU 107, which is an execution medium of programs stored in the image forming apparatus 101, controls operations of devices connected to the controller unit 102 via the respective I/Fs and a storage medium memory, for example.

The ROM 108, which is a read-only memory, stores a boot program required to start the system.

The RAM 109, which is a volatile memory, is a work memory that is required when executing a program.

The HDD 110, which is a storage medium such as a magnetic disk, stores control programs and image data.

The EEPROM 111, which is a non-volatile memory, stores setting values that are required when executing a program. Settings such as a unit cost setting that are required to calculate the charge are also stored in the EEPROM 111.

The device control I/F 114 controls input and output to and from the devices (the printer unit 105, scanner unit 106, and non-contact card processor 118) connected to the controller unit. The device control I/F 114 may be realized not only as a bus structure to which a plurality of devices can be connected, but may also include a plurality of I/Fs that are divided up on a one-to-one basis with each device.

The display I/F 112 outputs control information to the display unit 103.

The operation unit I/F 113 receives input information from the operation unit 104.

The image forming apparatus 101, which is connected to a local area network (LAN)/wide area network (WAN) 116 via the network I/F 115, issues notifications to a management server 117 on the LAN/WAN 116 and acquires information about charge-related information and deposit amounts.

Further, the image forming apparatus 101 communicates with the non-contact card processor 118 via the device control I/F 114, and performs reading or writing of the non-contact card.

The non-contact card is an example of a recording medium on which electronic money is recorded.

The functions of the image forming apparatus 101 and the information processing relating to flowcharts described below are realized by the CPU 107 loading a program stored in the HDD 110 in the RAM 109, and executing the program.

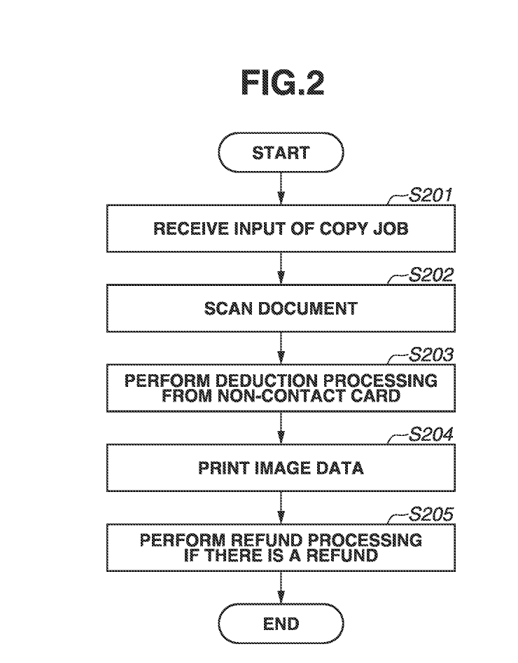

FIG. 2 illustrates basic charging processing with a non-contact card using a copy job as an example.

First, a user inputs a copy job by placing a document on an original document platen (i.e., reading portion) of the scanner unit 106, and performing settings relating to the copy job using the operation unit 104.

In step S201, the CPU 107 receives the copy job input.

In step S202, the CPU 107 issues a scanning start instruction to the scanner unit 106 to start a scanning operation.

In step S203, the CPU 107 calculates a required amount, and displays a calculated amount on the display unit 103. When the user swipes the non-contact card over the non-contact card processor 118, the CPU 107 issues a deduction instruction to the non-contact card processor 118.

After deduction, in step S204, the CPU 107 performs printing of the image data.

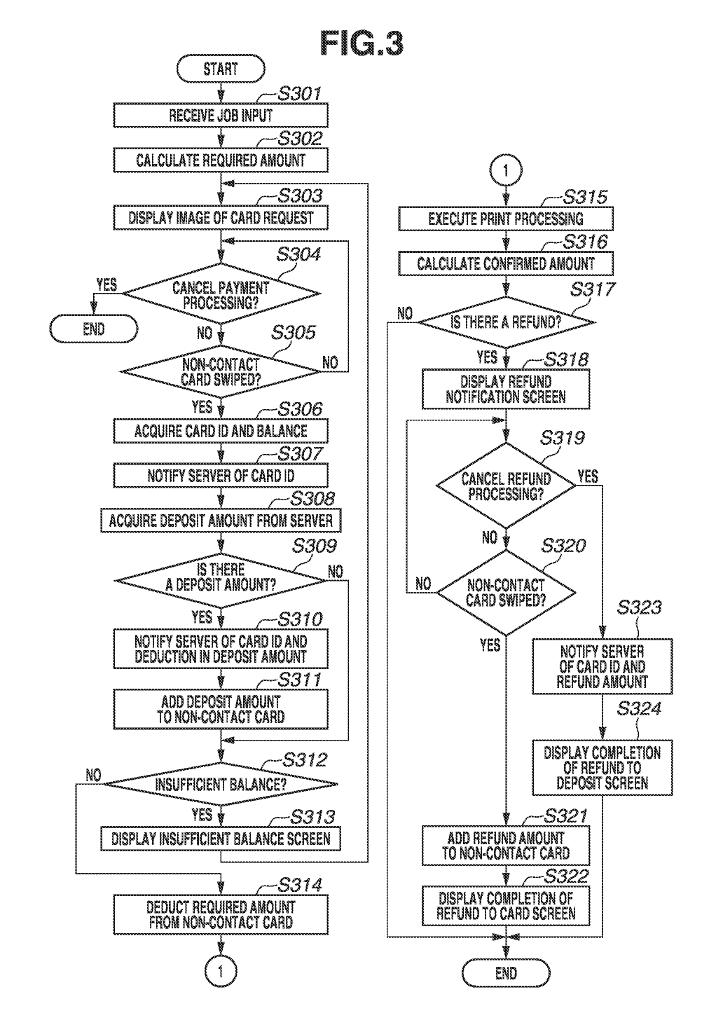

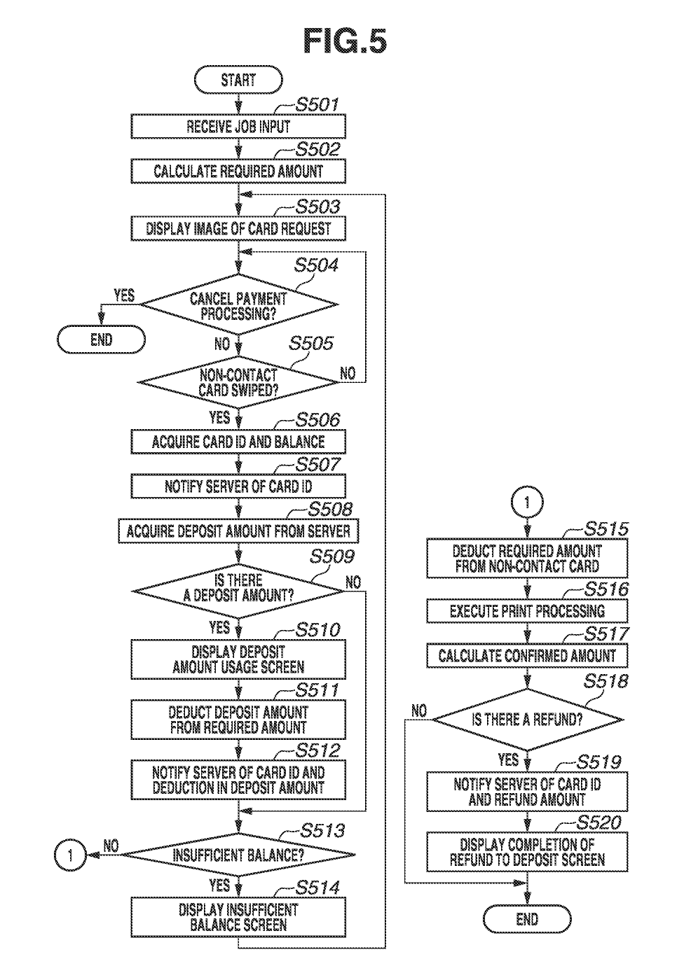

Finally, in step S205, the CPU 107 calculates a confirmed amount of the actual printing, and if there is a refund, performs refund processing. Details of the refund processing will be described below with reference to FIG. 3 or FIG. 5.

Next, FIG. 3 is a flowchart illustrating the details of the refund processing according to the first exemplary embodiment. In the first exemplary embodiment, even if the refund processing to the non-contact card is not performed, the refund processing is performed the next time the non-contact card is swiped.

In step S301, the CPU 107 receives a job input instruction from the operation unit 104 via the operation unit I/F 113. If the instruction is for a copy job, the CPU 107 issues a scanning start instruction to the scanner unit 106 via the device control I/F 114.

In step S302, the CPU 107 performs a calculation of the required amount. The required amount is an amount predicted to be required if the job is completed normally. The CPU 107 calculates the required amount based on, for example, information about a predicted color mode, and a paper size to be printed, and information about a unit cost set in the EEPROM 111.

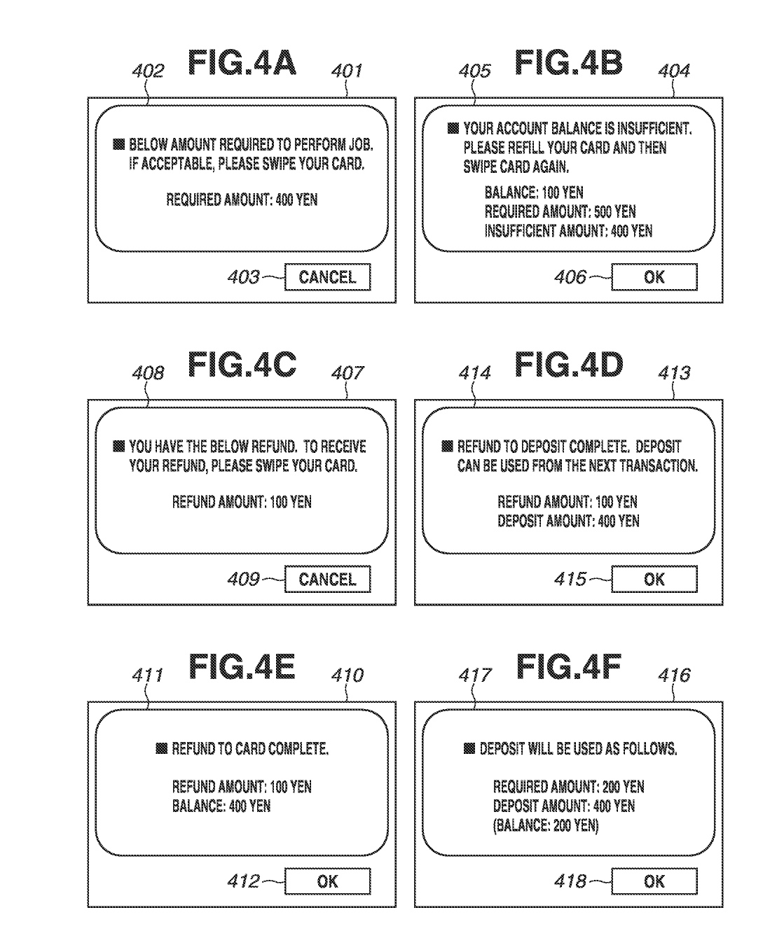

In step S303, the CPU 107 displays a card request screen and the required amount calculated in step S302 on the display unit 103 via the display unit I/F 112. An example of this display screen is illustrated in FIG. 4A. The card request screen 401 in FIG. 4A includes a message display section 402 and a cancel button 403. The CPU 107 continues the display until either the non-contact card is swiped over the non-contact card processor 118 or the cancel button 403 is pressed. If the cancel button 403 is pressed, the CPU 107 determines in step S304 that a cancel instruction has been issued (YES in step S304), and cancels charging processing. Then, in step S305, the CPU 107 determines whether the non-contact card has been swiped over the non-contact card processor 118. If the non-contact card has not been swiped (NO in step S305), the processing returns to step S304. If the non-contact card has been swiped (YES in step S305), the processing proceeds to step S306.

In step S306, the CPU 107 acquires card identification (ID) and a balance of the swiped non-contact card from the non-contact card processor 118 via the device control I/F 114.

The card ID is an example of identification information identifying the non-contact card.

In step S307, the CPU 107 notifies the management server 117 of the card ID.

In step S308, the CPU 107 acquires from the management server 117 a deposit amount corresponding to the card ID. The deposit amount is a cumulative amount that has not been refunded to the non-contact card.

In other words, in the present exemplary embodiment, a card ID identifying a non-contact card on which electronic money relating to a balance is recorded and this balance (a cumulative amount that has not been refunded to the non-contact card) are associated and recorded in a non-volatile memory of the management server 117. In the present exemplary embodiment, although these pieces of associated information will be described below as being recorded in the non-volatile memory of the management server 117, they may also be recorded in the HDD 110 of the image forming apparatus 101. The non-volatile memory of the management server 117 and the HDD 110 of the image forming apparatus 101 are examples of an information storage device.

In step S309, the CPU 107 confirms whether there is a deposit amount. If there is a deposit amount (YES in step S309), the CPU 107 performs the refund processing of steps S310 and S311. If there is not a deposit amount (NO in step S309), the processing proceeds to step S312 without performing the refund processing.

In other words, in step S309, the CPU 107 determines whether the same card ID as that acquired from the non-contact card which has been swiped over the non-contact card processor 118 is associated with balance amount information and stored in the management server 117.

In step S310, to perform the refund processing, the CPU 107 issues a deposit amount deduction notification including the card ID and the deposit amount to the management server 117. The management server 117 receives this deduction notification, and updates the deposit amount corresponding to the card ID.

In step S311, the CPU 107 issues an add instruction for the deposit amount to the non-contact card processor 118 via the device control I/F 114. Consequently, the balance of the electronic money stored on the non-contact card increases.

In the present exemplary embodiment, the processing order of steps S310 and S311 may be reversed.

Next, in step S312, the CPU 107 checks whether the balance is insufficient. The CPU 107 determines whether the balance is insufficient by comparing the balance of the non-contact card and the required amount calculated in step S302.

If it is determined that the balance is insufficient (YES in step S312), in step S313, the CPU 107 displays an insufficient balance screen on the display unit 103 via the display unit I/F 112. An example of this display screen is illustrated in FIG. 4B. The insufficient balance screen 404 in FIG. 4B includes a message display section 405 and an OK button 406. When the OK button 406 is pressed, the processing proceeds to step S303, and the CPU 107 again displays the card request screen. If it is determined in step S312 that the balance is not insufficient (NO in step S312), the processing proceeds to step S314.

In step S314, the CPU 107 issues a required amount deduction instruction to the non-contact card processor 118 via the device control I/F 114. Consequently, the balance of the electronic money stored on the non-contact card decreases.

After the deduction processing, in step S315, the CPU 107 issues a print instruction to the printer unit 105 via the device control I/F 114.

After the print processing, in step S316, the CPU 107 performs calculation of the confirmed amount. The confirmed amount is an amount that has been actually required after the job execution. If the print processing has finished normally, the required amount calculated in step S302 and the confirmed amount generally match. However, if the print processing has not finished normally due to a jam or the like, a difference arises.

In step S317, the CPU 107 confirms whether a difference in the amounts has occurred, and whether the refund processing is required. If there is no refund (NO in step S317), the CPU 107 ends the charging processing. If there is a refund (YES in step S317), the CPU 107 performs the processing in step S318 and the subsequent steps.

In step S318, the CPU 107 displays a refund notification screen on the display unit 103 via the display unit I/F 112. An example of this display screen is illustrated in FIG. 4C. The refund notification screen 407 in FIG. 4C includes a message display section 408 and a cancel button 409. The CPU 107 continues the display until either the non-contact card is swiped over the non-contact card processor 118 or the cancel button 409 is pressed.

If the cancel button 409 is pressed, in step S319, the CPU 107 determines that a cancel instruction has been issued (YES in step S319), and cancels the refund processing to the non-contact card. Then, the processing proceeds to step S323.

In step S323, the CPU 107 issues a refund amount notification including the card ID and the refund amount to the management server 117. The management server 117 receives this refund amount notification, adds the refund amount from this transaction to the deposit amount corresponding to the card ID recorded in the memory, and updates the deposit amount.

In step S324, the CPU 107 displays a screen indicating that the refund to the management server has been completed on the display unit 103 via the display unit I/F 112. An example of the display screen at this stage is illustrated in FIG. 4D. The screen 413 in FIG. 4D indicating that the refund to the management server has been completed includes a message display section 414 and an OK button 409. When the OK button 415 is pressed, the CPU 107 ends the charging processing.

In step S320, the CPU 107 determines whether the non-contact card has been swiped over the non-contact card processor 118. If the non-contact card has not been swiped (NO in step S320), the processing returns to step S319. If the non-contact card has been swiped (YES in step S320), the processing proceeds to step S321. In other words, in step S320, the CPU 107 determines whether the non-contact card has been swiped over the non-contact card processor 118, and whether communication is possible with the non-contact card.

In step S321, the CPU 107 issues an add instruction for the refund amount to the non-contact card processor 118 via the device control I/F 114. Consequently, the balance stored on the non-contact card increases.

In step S322, the CPU 107 displays a screen indicating that the refund to the non-contact card has been completed on the display unit 103 via the display unit I/F 112. An example of the display screen at this stage is illustrated in FIG. 4E. The screen 410 in FIG. 4E indicating that the refund to the non-contact card has been completed includes a message display section 411 and an OK button 412. When the OK button 412 is pressed, the CPU 107 ends the charging processing.

Based on the above series of processes, even if the refund processing to the non-contact card is not performed, a refund is made the next time the non-contact card is swiped.

While a case is described in the first exemplary embodiment in which refund authority is given to the non-contact card processor, in a second exemplary embodiment, a case will be described in which refund authority is not given thereto.

FIG. 5 is a flowchart illustrating details of the refund processing according to the second exemplary embodiment.

Since steps S501 to S508 are the same as steps S301 to S308 of the first exemplary embodiment, a description thereof will be omitted here.

In step S509, the CPU 107 confirms whether there is a deposit amount. If there is a deposit amount (YES in step S509), the CPU 107 performs processing for using the deposit amount as illustrated in steps S510 to S512. If there is not a deposit amount (NO in step S509), the processing proceeds to step S513.

In step S510, the CPU 107 displays a deposit amount usage screen on the display unit 103 via the display unit I/F 112. An example of the display screen at this stage is illustrated in FIG. 4F. The deposit amount usage screen 416 in FIG. 4F includes a message display section 417 and an OK button 418. When the OK button 418 is pressed, the CPU 107 closes the deposit amount usage screen 416.

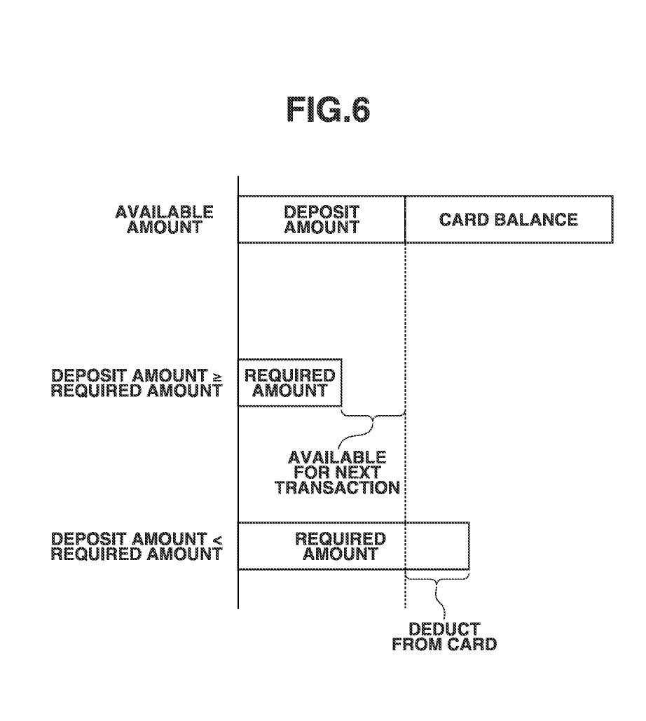

In step S511, the CPU 107 deducts the deposit amount from the required amount. The deduction method will be described in more detail below with reference to FIG. 6.

In step S512, the CPU 107 issues a deduction notification including the card ID and the deposit amount to the management server 117. The management server 117 receives this deduction notification, and updates the deposit amount corresponding to the card ID.

Since steps S513 to S517 are the same as steps S312 to S316 of the first exemplary embodiment, a description thereof will be omitted here.

In step S518, the CPU 107 confirms whether a difference in the amounts has occurred, and whether the refund processing is required. If there is no refund (NO in step S518), the CPU 107 ends the charging processing. If there is a refund (YES in step S518), the CPU 107 performs the processing from step S519 onwards.

In step S519, the CPU 107 issues a refund amount notification including the card ID and the refund amount to the management server 117. The management server 117 receives this refund amount notification, adds the refund amount at this transaction to the deposit amount corresponding to the card ID, and updates the deposit amount.

In step S520, the CPU 107 displays a screen indicating that the refund to the management server has been completed on the display unit 103 via the display unit I/F 112. An example of the display screen at this stage is the same as that in the first exemplary embodiment. When the OK button 415 is pressed, the CPU 107 ends the charging processing.

Next, the processing for deducting the deposit amount from the required amount of step S511 will be described in more detail with reference to FIG. 6. An available amount illustrated in FIG. 6 is obtained by adding the deposit amount stored in the management server 117 and the balance of the non-contact card. The user can use services within this available amount. If the deposit amount is equal to or more than the required amount, all of the required amount is paid from the deposit amount, and the remaining deposit amount can be used in the next transaction. On the other hand, if the deposit amount is less than the required amount, the required amount is paid from all of the deposit amount and the balance of the non-contact card.

Based on the above series of processes, even if refund authority is not given to a non-contact card processor, the user can use a refund amount the next time the card is used.

According to the above-described respective exemplary embodiments, even when the refund processing to the non-contact card is not performed because the user does not notice that there has been a refund, the refund processing is performed the next time the non-contact card is swiped. Therefore, the user does not lose any money. Further, even if the user leaves without performing the refund processing, processing can proceed by a different user cancelling the refund processing. Namely, even when the user does not notice that there is a refund and does not swipe his/her card again, the refund processing can be performed.

Further, even if the card processor does not have the authority of refilling or cancelling, the refund processing can be performed and the refund can be used the next time the card is used.

The exemplary embodiments of the present invention have been described above. However, the present invention is not limited to the embodiments described above and can be modified in various ways within the scope of the following claims.

Although in the above exemplary embodiments, a non-contact card is employed as an example, a portable terminal such as a mobile phone or a smartphone having an integrated chip (IC) on which electronic money is recorded may also be used.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-190776 filed Sep. 13, 2013, which is hereby incorporated by reference herein in its entirety.

What is claimed is:

1. An image forming apparatus comprising:
an obtaining unit configured to obtain from a device on which electronic money is recorded, identification information for identifying the device and electronic money information;
a deduction unit configured to deduct an amount required for executing a print process based on the electronic money information;
a storage unit configured to store balance information that indicates a balance relating to the print process by associating the balance information with the identification information; and
a refund unit configured to refund the balance indicated by the balance information associated with the identification information in a case where the identification information is obtained by the obtaining unit to execute a different print process.

2. The image forming apparatus according to claim 1, further comprising a determination unit configured to determine whether identification information that is the same as the identification information obtained by the obtaining unit is stored in the storage unit.

3. The image forming apparatus according to claim 1, wherein the refund unit is configured to display the balance on a display unit and request a user to swipe the device because there is a refund, and if communication is possible with the device, write the balance to the device.

4. The image forming apparatus according to claim 1, further comprising a calculation unit configured to calculate the amount required for executing the print process before the print process is executed,
wherein the deduction unit is configured to deduct the amount calculated by the calculation unit.

5. The image forming apparatus according to claim 4,
wherein the calculation unit is configured to calculate a confirmed amount after the print process has been executed, and
wherein the storage unit is configured to store information about a difference between the required amount and the confirmed amount as the balance information.

6. The image forming apparatus according to claim 1, wherein the device is a non-contact IC card or a mobile terminal.

7. The image forming apparatus according to claim 1, further comprising a usage unit configured to use the balance indicated by the balance information associated with the identification information for the different print process.

8. The image forming apparatus according to claim 7, wherein the usage unit is configured to, if the balance is equal to or more than the required amount required for executing the different print process, execute the different print process using the balance, and if the balance is less than the required amount required for executing the different print process, execute the different print process using the balance and an amount deducted from a recording medium that is identified by the identification information.

9. The image forming apparatus according to claim 7, wherein the usage unit is configured to display on a display unit a message that the balance will be used to execute the different print process.

10. The image forming apparatus according to claim 7, wherein the balance is deducted if the balance is used by the usage unit.

11. An information processing method executed by an image forming apparatus, the method comprising:
obtaining, from a device on which electronic money is recorded, identification information for identifying the device and electronic money information;
deducting an amount required for executing a print process based on the electronic money information;
storing balance information associated with the identification information that indicates a balance relating to the print process; and
refunding the balance indicated by the balance information associated with the identification information in a case where the identification information is obtained by the obtaining unit to execute a different print process.

12. A storage medium storing a program that causes a computer to execute a method, the method comprising:
obtaining, from a device on which electronic money is recorded, identification information for identifying the device and electronic money information;
deducting an amount required for executing a print process based on the electronic money information;
storing balance information that indicates a balance relating to the print process by associating the balance information with the identification information; and
refunding the balance indicated by the balance information associated with the identification information in a case where the identification information is obtained by the obtaining unit to execute a different print process.
